(19) United States
(12) Patent Application Publication
(10) Pub. No.: US 2025/0183333 A1
(43) Pub. Date: Jun. 5, 2025

(54) FUEL CELL STACK

(71) Applicant: TOYOTA BOSHOKU KABUSHIKI KAISHA, Aichi-ken (JP)

(72) Inventor: Kunihiro YAMAURA, Tokai-shi (JP)

(73) Assignee: TOYOTA BOSHOKU KABUSHIKI KAISHA, Aichi-ken (JP)

(21) Appl. No.: 18/953,473

(22) Filed: Nov. 20, 2024

(30) Foreign Application Priority Data
Nov. 30, 2023 (JP) 2023-202969

(51) Int. Cl. H01M 8/0276; H01M 8/0206; H01M 8/0286; H01M 8/1004; H01M 8/241

(52) U.S. Cl. CPC H01M 8/0276; H01M 8/0206; H01M 8/0286; H01M 8/1004; H01M 8/241

(57) ABSTRACT

A fuel cell stack includes single cells stacked in a thickness direction. Each of the single cells includes a membrane electrode gas diffusion layer assembly and multiple plate-shaped separators sandwiching the membrane electrode gas diffusion layer assembly from opposite sides in the thickness direction. Each separator has a hole. The adjacent separators of any two single cells stacked in the thickness direction include a weld portion. Specifically, the separators are welded to each other around the entirety of the hole, so as to form the weld portion. The hole of each separator has a shape elongated in a specified direction. Each weld portion includes a distant section located in a long part and multiple close sections in the long part. The close sections are closer to the hole than the distant section is to the hole.

### CROSS-REFERENCE TO RELATED APPLICATIONS

This application is based upon and claims the benefit of priority from prior Japanese Patent Application No. 2023-202969, filed on Nov. 30, 2023, the entire contents of which are incorporated herein by reference.

### BACKGROUND

### 1. Field

The present disclosure relates to a fuel cell stack.

### 2. Description of Related Art

As disclosed in Japanese Laid-Open Patent Publication No. 2019-61754, a fuel cell stack is formed by stacking single cells in a thickness direction. Each single cell is formed by sandwiching a membrane electrode gas diffusion layer assembly with plate-shaped separators from the opposite sides in the thickness direction. The separators include holes through which fluids such as fuel gas (e.g. hydrogen) and oxidation gas (e.g. air) flow to the membrane electrode gas diffusion layer assembly. The holes extend through the separator in the thickness direction.

In the fuel cell stack, the adjacent separators of any two single cells stacked in the thickness direction include weld portions. Specifically, the separators are welded to each other around the entirety of each hole, so as to form the weld portion. This welding serves to seal the periphery of the hole. Through the holes in the adjacent separators, fuel gas flows to the anode side of the membrane electrode gas diffusion layer assembly, while oxidation gas flows to the cathode side of the membrane electrode gas diffusion layer assembly. As a result, power is generated based on the reaction between the fuel gas and the oxidation gas at the membrane electrode gas diffusion layer assembly.

When fluids such as fuel gas or oxidation gas flow through the holes in the separators of the single cells, the pressure of the fluids generates a force that acts on the weld portions in a direction that separates the welded separators from each other. If the shape of each hole is elongated in a specified direction, the force tends to be greater at long parts of the weld portion than at other parts of the weld portion. The long parts correspond to the longitudinal direction of the hole. As a result, there is a risk that the separators may peel off each other at the long parts of the weld portions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a fuel cell stack includes single cells stacked in a thickness direction. Each of the single cells includes a membrane electrode gas diffusion layer assembly, and multiple plate-shaped separators sandwiching the membrane electrode gas diffusion layer assembly from opposite sides in the thickness direction. Each separator includes a hole through which a fluid is configured to flow to the membrane electrode gas diffusion layer assembly. The hole extends through the separator in the thickness direction. A weld portion is provided between adjacent separators of any two of the single cells stacked in the thickness direction. The weld portion is formed by welding the separators to each other around an entirety of the hole. The hole of each separator has a shape elongated in a specified direction. Each weld portion includes a distant section located in a long part of the weld portion, and multiple close sections in the long part. The long part corresponds to a part of an inner edge of the hole that extends in a longitudinal direction of the hole. The close sections are closer to the hole than the distant section is to the hole.

Other features and aspects will be apparent from the following detailed description, the drawings, and the claims.

### BRIEF DESCRIPTION OF THE DRAWINGS

FIG. 1 is an exploded perspective view of a single cell.

FIG. 2 is a front view showing a state in which a separator incorporated in the single cell shown in FIG. 1 is viewed from the direction of arrow A.

FIG. 3 is an enlarged view illustrating a hole and a weld portion in the separator shown in FIG. 2.

FIG. 4 is an enlarged view illustrating a modification of the weld portion shown in FIG. 3.

FIG. 5 is an enlarged view illustrating a modification of the weld portion shown in FIG. 3.

FIG. 6 is an enlarged view illustrating a modification of the weld portion shown in FIG. 3.

FIG. 7 is an enlarged view illustrating a modification of the weld portion shown in FIG. 3.

FIG. 8 is an enlarged view illustrating a modification of the weld portion shown in FIG. 3.

FIG. 9 is an enlarged view illustrating a modification of the hole shown in FIG. 2.

FIG. 10 is an enlarged view illustrating a modification of the hole shown in FIG. 2.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

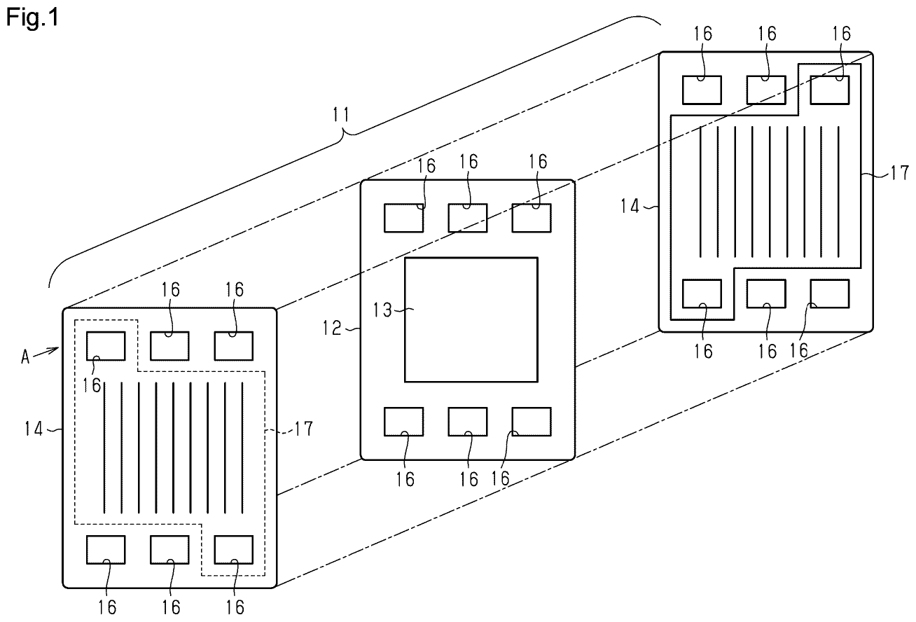

A fuel cell stack according to one embodiment will now be described with reference to FIGS. 1 to 3.

FIG. 1 shows a single cell 11 used to form the fuel cell stack. The single cell 11 includes a plastic plate 12, a membrane electrode gas diffusion layer assembly 13, and separators 14. The plastic plate 12 is formed to have the shape of a rectangular frame. The outer edge of the membrane electrode gas diffusion layer assembly 13 is joined to the plastic plate 12. The plastic plate 12 and the membrane electrode gas diffusion layer assembly 13 are sandwiched by the separators 14 from the opposite sides in the thickness direction. The separators 14 are made of metal such as stainless steel, titanium, or aluminum, and formed have the shape of a rectangular plate.

The fuel cell stack is formed by stacking the single cells 11 in the thickness direction. The plastic plates 12 and the separators 14 of the cells 11 each have holes 16 extending through the plastic plates 12 and the separators 14 in the thickness direction. Three of the holes 16 are located at one end of the single cell 11 in the long-side direction, and the other three are located at the other end of the single cell 11 in the long-side direction. One of the holes 16 at one end in the long-side direction of the single cell 11 is paired with one of the holes 16 at the other end. Each pair of the holes 16 is used to allow a fluid (e.g. fuel gas such as hydrogen, oxidation gas such as air, or coolant) to flow therethrough. A seal member 17 is arranged between each separator 14 and the plastic plate 12. The seal members 17 are disposed on the surfaces of the plastic plate 12 on the opposite sides in the thickness direction.

The seal member 17 arranged on the front side of the plastic plate 12 surrounds a pair of the holes 16 positioned along one of the two diagonal lines of the plastic plate 12 and the corresponding separator 14. The seal member 17 also surrounds the anode-side surface of the membrane electrode gas diffusion layer assembly 13. This allows fuel gas to flow along the anode-side surface of the membrane electrode gas diffusion layer assembly 13 via the pair of the holes 16. Also, the seal member 17 arranged on the back side of the plastic plate 12 surrounds a pair of the holes 16 positioned along the other one of the two diagonal lines of the plastic plate 12 and the corresponding separator 14. The seal member 17 also surrounds the cathode-side surface of the membrane electrode gas diffusion layer assembly 13. This allows oxidation gas to flow along the cathode-side surface of the membrane electrode gas diffusion layer assembly 13 via the pair of the holes 16.

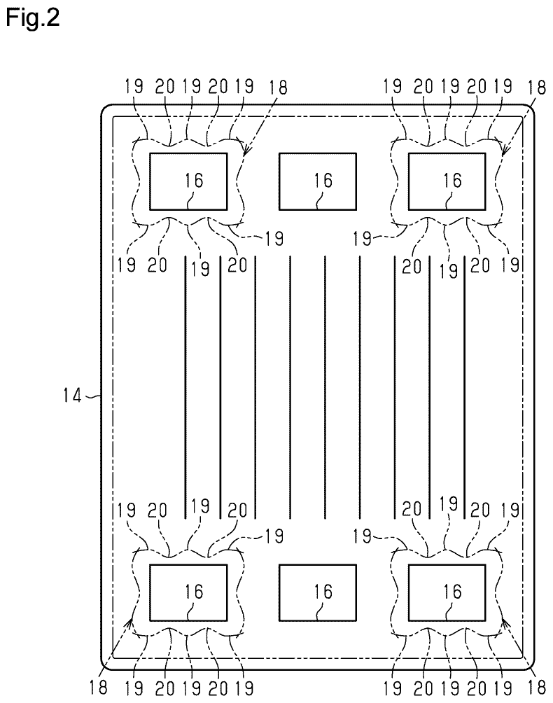

FIG. 2 shows one of the separators 14 of the single cell 11 that is located on the anode side of the membrane electrode gas diffusion layer assembly 13 as viewed in the direction of arrow A in FIG. 1. This separator 14 is adjacent to a cathode-side separator 14 of another single cell 11 that is in contact with the above-described single cell 11. The separators 14 adjacent to each other in this manner include weld portions 18, each of which is formed by welding the separators 14 to each other around the entirety of the corresponding hole 16. The weld portions 18 are formed around two pairs of the holes 16 that are located on the diagonal lines of the separator 14, and are not formed around the holes 16 located at the center in the short-side direction of the separator 14. Also, the outer edges of the adjacent separators 14 are welded to each other. This allows coolant to flow through the space between the adjacent separators 14 via the holes 16 located at the center of the separators 14 in the short-side direction.

In the fuel cell stack, in which the multiple single cells 11 are stacked, the fuel gas flows along the anode-side surface of the membrane electrode gas diffusion layer assembly 13, and the oxidation gas flows along the cathode-side surface of the membrane electrode gas diffusion layer assembly 13. When the fuel gas and the oxidation gas respectively flow along the anode-side surface and the cathode-side surface of the membrane electrode gas diffusion layer assembly 13, power is generated based on the reaction between the fuel gas and the oxidation gas in the membrane electrode gas diffusion layer assembly 13. In order to limit an increase in the temperature of the fuel cell stack caused by such power generation, the coolant flows through the space between the separators 14 of adjacent single cells 11. The coolant cools the fuel cell stack.

### Detail of Weld Portion 18

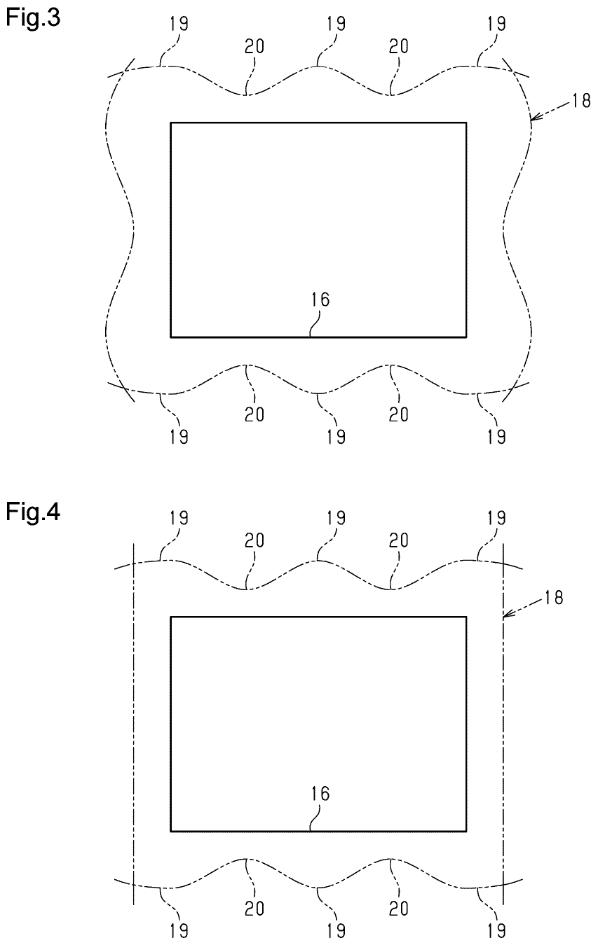

As shown in FIG. 3, the hole 16 of the separator 14 has a shape that is elongated in a specified direction; more specifically, has a rectangular shape. The weld portion 18 includes distant sections 19 and close sections 20. The distant sections 19 are located at long parts of the weld portion 18. The long parts correspond to parts of the inner edge of the hole 16 that extend in the longitudinal direction, that is, in a long-side direction of the hole 16. The close sections 20 are closer to the hole 16 than the distant sections 19 in the long parts of the weld portion 18. The close sections 20 are formed by curving sections of each long part of the weld portion 18 that are different from the distant sections 19 such that the curved sections protrude toward the hole 16.

Specifically, the distant sections 19 and the close sections 20 are formed by curving the long parts of the weld portion 18 into wavy shapes. The distant sections 19 are formed at sections in each wavy long part of the weld portion 18 that protrude away from the hole 16. The close sections 20 are formed at sections in each wavy long part of the weld portion 18 that protrude toward the hole 16.

Further, the close sections 20 are formed at sections in each long part of the weld portion 18 on opposite sides of the center of the long part. The weld portion 18 also includes short parts that extend in a direction different from that of the long parts. The short parts are connected to the long parts. The short parts extend along the short sides of the hole 16. The long parts of the weld portion 18 are connected to the short parts at the distant sections 19. Specifically, some of the distant sections 19 intersect with the short parts, so that the long parts and the short parts of the weld portion 18 are connected to each other.

The short parts of the weld portion 18 are also curved into wavy shapes. The pitch of the wavy shape of the long parts of the weld portion 18 is shorter than the pitch of the wavy shape of the short parts.

Operation and advantages of the fuel cell stack according to the present embodiment will now be described.
(1) The weld portion 18, which is formed by welding the adjacent separators 14 to each other around the entirety of the hole 16, receives a force acting in a direction that separates the separators 14 from each other based on the pressure of the fluid flowing through the hole 16. The force is likely to be greater in the long parts of the weld portion 18 than in the short parts, which are different from the long parts of the weld portion 18. In other words, the force is more likely to be increased at the positions in the weld portion 18 that correspond to the long sides of the hole 16 than at the positions that correspond to the short sides of the hole 16. To address this, the weld portion 18 includes the distant sections 19 and the close sections 20, which will be discussed below. The distant sections 19 and the close sections 20 are formed in the long parts of the weld portion 18, which correspond to the long-side direction of the hole 16. The close sections 20 are formed at positions closer to the hole 16 than the distant sections 19 are to the hole 16. In each long part of the weld portion 18, the force acting in the direction that separates the separators 14 from each other in sections that are closer to the hole 16. Thus, in a case in which multiple close sections 20 are provided in each long part of the weld portion 18, the close sections 20 receive the force in a dispersed manner, thereby preventing the force from being locally increased in the long part of the weld portion 18. This prevents the welded separators 14 from coming off each other by the above-described force at the long parts of the weld portion 18.
(2) The close sections 20 are formed by curving sections of each long part of the weld portion 18 that are different from the distant sections 19 such that the curved sections protrude toward the hole 16. As a result, multiple close sections 20, connected to the distant sections 19, are formed in the above-described long parts of the weld portion 18.
(3) Each long part of the weld portion 18 is curved into a wavy shape to form the distant sections 19 and the close sections 20 in the long part. This facilitates the formation of the close sections 20 in the long parts of the weld portion 18.
(4) The above-described force that acts on each long part of the weld portion 18 to separate the separators 14 from each other tends increase at a position corresponding to the center of the long part. The close sections 20 in each long part of the weld portion 18 are formed at positions on the opposite sides of the center of the long part. Thus, when the above-described force is dispersed to and received by the close sections 20, the close sections 20 evenly receive the dispersed force. As a result, the force is prevented from being locally increased in each long part of the weld portion 18.
(5) The long parts of the weld portion 18 are connected to the short parts at the distant sections 19 of the weld portion 18. This configuration prevents each section of the weld portion 18 at which the long part and the short part intersect from forming a shape that is prone to stress concentration when the above-described force acts to separate the separators 14 from each other. Accordingly, at each position where a section of the weld portion 18 that corresponds to the long side of the hole 16 and a section that corresponds to the short side of the hole 16 intersect, the weld is prevented from peeling off in a direction that separates the separators 14 from each other, which would otherwise be caused by stress concentration.

The above-described embodiment may be modified as follows. The above-described embodiment and the following modifications can be combined as long as the combined modifications remain technically consistent with each other.

Instead of causing the long parts and the short parts of the weld portion 18 to intersect with each other, the long parts and the shorts part may be connected to each other by rounded sections that protrude away from the hole 16.

As shown in FIG. 4, the short parts of the weld portion 18, that is, the parts that correspond to the short sides of the hole 16, may be formed as straight lines.

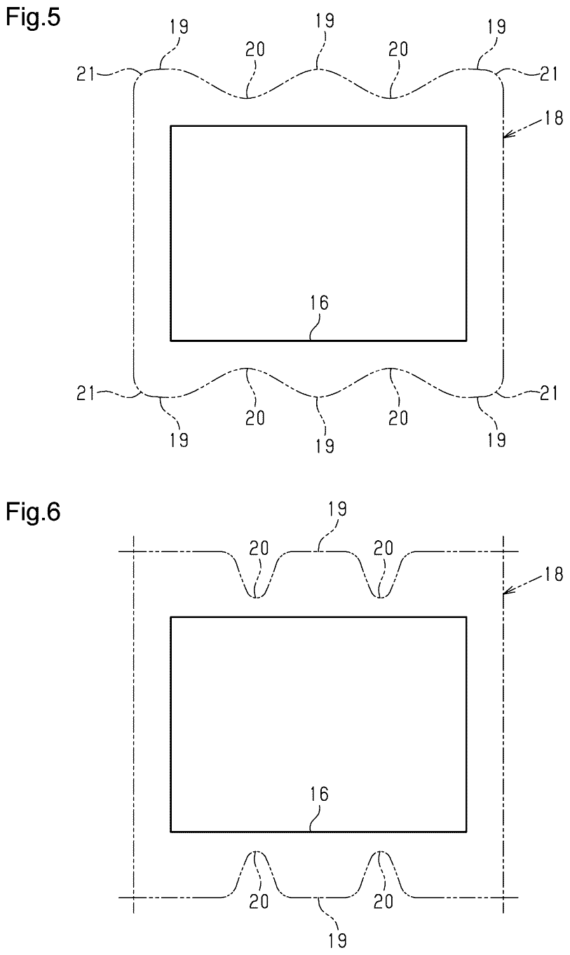

In a case in which the short parts of the weld portion 18 are formed as straight lines as shown in FIG. 5, the short parts and parts corresponding to the long sides of the hole 16 may be connected to each other by rounded sections 21 that protrude away from the hole 16.

As shown in FIG. 6, straight distant sections 19 may be formed in the long parts of the weld portion 18, which correspond to the long sides of the hole 16. Further, the close sections 20 may be formed by curving sections of each long part of the weld portion 18 that is different from the distant sections 19 such that the curved sections protrude toward the hole 16.

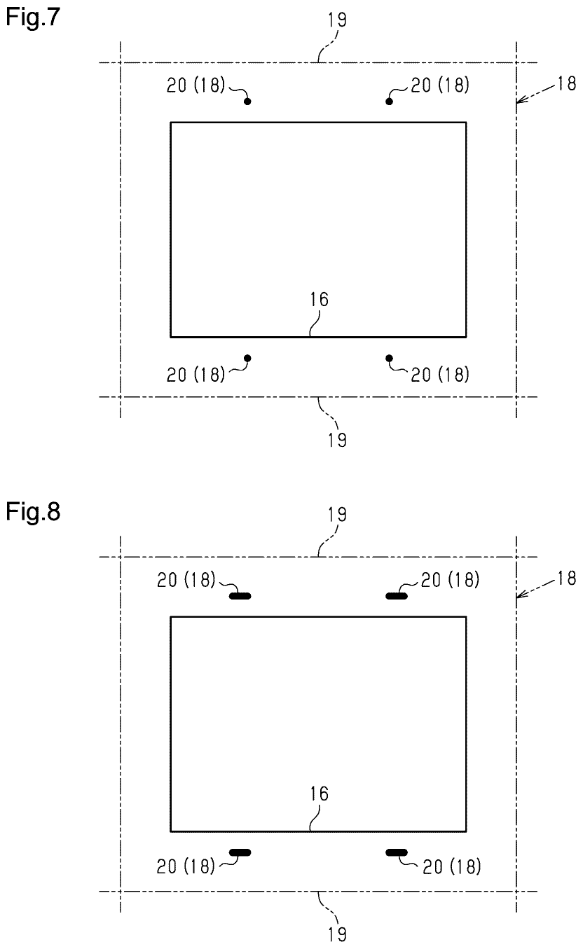

As shown in FIG. 7, straight distant sections 19 may be formed at sections of the weld portion 18 that correspond to the long sides of the hole 16. Further, the weld portion 18 may include multiple close sections 20, at which the separators 14 are spot-welded to each other at positions spaced apart from the distant sections 19 toward the hole 16.

As shown in FIG. 8, straight distant sections 19 may be formed at sections of the weld portion 18 that correspond to the long sides of the hole 16. Further, the weld portion 18 may include multiple close sections 20, at which the separators 14 are welded to each other at positions spaced apart from the distant sections 19 toward the holes 16. The close sections 20 extend parallel to the long sides of the hole 16.

The number of the close sections 20 in each long part of the weld portion 18 may be increased. In this case, the pitch of the wavy shape in each long part of the weld portion 18 may be constant or may be different between the section corresponding to the center of the long part and the sections corresponding to the ends.

If the pitch of the wavy shape in the weld portion 18 is differentiated in each long part between the section corresponding to the center and the sections corresponding to the ends, the following is achieved. It is possible to increase the adjustment range for modifying the pitch to prevent the separators 14 from peeling apart under the influence of the force that occurs when the pressure of the fluid flowing through the hole 16 acts in a direction that separates the separators 14 from each other.

The pitch of the wavy shape of the long parts of the weld portion 18 does not necessarily need to be shorter than the pitch of the wavy shape of the short parts.

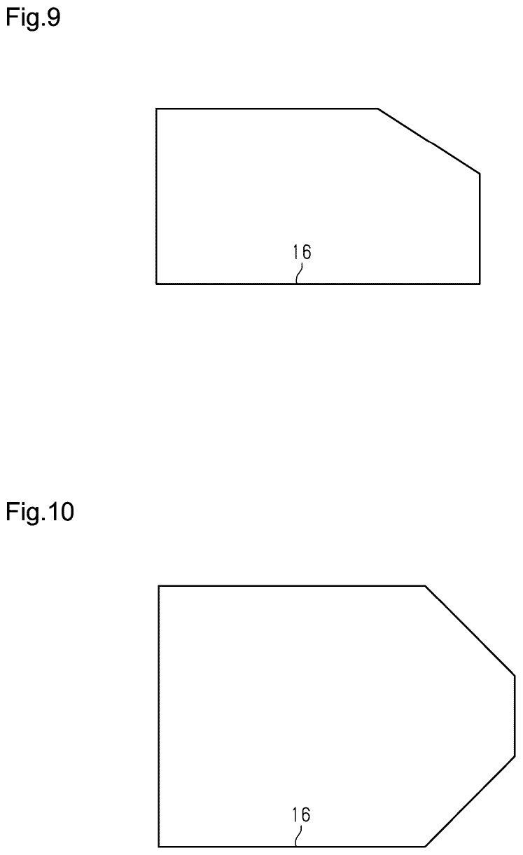

As shown in FIGS. 9 and 10, each hole 16 may have a polygonal shape extending in a specific direction. In the examples shown in FIGS. 9 and 10, the lateral direction in the drawings corresponds to the longitudinal direction of the holes 16.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A fuel cell stack, comprising:
single cells stacked in a thickness direction, wherein
each of the single cells includes:
a membrane electrode gas diffusion layer assembly; and
multiple plate-shaped separators sandwiching the membrane electrode gas diffusion layer assembly from opposite sides in the thickness direction,
each separator includes a hole through which a fluid is configured to flow to the membrane electrode gas diffusion layer assembly, the hole extending through the separator in the thickness direction,
a weld portion is provided between adjacent separators of any two of the single cells stacked in the thickness direction, the weld portion being formed by welding the separators to each other around an entirety of the hole,
the hole of each separator has a shape elongated in a specified direction, and
each weld portion includes:
a distant section located in a long part of the weld portion, the long part corresponding to a part of an inner edge of the hole that extends in a longitudinal direction of the hole, and
multiple close sections in the long part, the close sections being closer to the hole than the distant section is to the hole.

2. The fuel cell stack according to claim 1, wherein each close section is formed by curving a section of the long part of the weld portion that is different from the distant section such that the curved section protrudes toward the hole.

3. The fuel cell stack according to claim 2, wherein
the long part of the weld portion is curved into a wavy shape,
the distant section is formed in a section of the wavy long part in the weld portion that protrudes away from the hole, and
each close section is formed in a section of the wavy long part in the weld portion that protrudes toward the hole.

4. The fuel cell stack according to claim 1, wherein the close sections include close sections that are formed in the long part of the weld portion on opposite sides of a center of the long part.

5. The fuel cell stack according to claim 3, wherein
the weld portion includes a short part that extends in a direction different from the long part and is connected to the long part, and
the long part of the weld portion is connected to the short part via the distant section.
